(19) United States
(12) Patent Application Publication
(10) Pub. No.: US 2008/0118013 A1
(43) Pub. Date: May 22, 2008

(54) APPARATUS AND METHOD FOR REDUCING INTERFERENCE BY SPECTRAL SHAPING OF CLOCKING SIGNALS

(76) Inventors: Marvin L. Vis, Boulder, CO (US); James Maligeorgos, Austin, TX (US); G. Diwakar Vishakhadatta, Austin, TX (US); Russell Croman, Austin, TX (US)

Correspondence Address: JOHNSON & ASSOCIATES, PO BOX 90698, AUSTIN, TX, 78709-0698, US

(21) Appl. No.: 11/562,401

(22) Filed: Nov. 21, 2006

(51) Int. Cl. H04L 7/00

(52) U.S. Cl. 375/354

(57) ABSTRACT

A method and apparatus is provided for use in a time domain isolated apparatus in which the operation of various radio-interfering circuits can be altered or controlled to mitigate levels of interference to the radio to acceptable levels based on current or predicted link requirements. Techniques are provided that allow some use of signal processing and other digital circuitry while the RF circuitry is operating.

### FIELD OF THE INVENTION

This invention relates generally to RF systems and, more particularly, to systems and methods for reducing interference in RF systems, such as a highly integrated RF system.

### BACKGROUND OF THE INVENTION

In various types of mixed signal circuits, interference from the various circuit partitions themselves can interfere with other associated partitions and cause degradation of the overall system performance. These types of problems may be especially evident in highly integrated systems, where the operation of one portion of a device can interfere with the operation of another portion of the device due to localized proximity effects. For example, in a system containing both sensitive analog circuitry and digital circuitry, the electrical and magnetic coupling between the analog and digital circuitry can cause significant impairment of the analog circuits through interference from the digital circuitry, making a high-performance and highly integrated implementation of the system very difficult to achieve.

In a typical prior art analog radio-frequency (RF) receiver, transmitter, or transceiver, RF circuitry generally resides in a different circuit partition (e.g., integrated circuit (IC), die, etc.) than does signal-processing circuitry (e.g., baseband), partly due to the problem of interference. RF circuitry typically includes analog circuitry that has a relatively high sensitivity to noise and interference. Furthermore, the RF circuitry in some applications, for example, in a mobile telephone apparatus, may have to detect signals as small as a few nano-volts in amplitude. The performance of a device may suffer as a result of noise and interference from sources external or even internal to the communication apparatus.

In a typical communication apparatus, such as a mobile telephone apparatus, digital circuitry produces digital signals with relatively small rise and fall times, or with fast transitions or sharp edges. Furthermore, those signals often have relatively high frequencies. In addition, typical digital components run at a fixed clock frequency. As a result, these high frequency signals, and their harmonics, can interfere with, and adversely impact the performance of, the RF circuitry. As a result, typical prior art communication devices use more than one circuit partition. For example, one partition may include the RF circuitry, while a second partition includes the digital circuitry.

Using more than one partition for RF circuitry and the digital circuitry, however, has several disadvantages, such as increased component count, size, and overall cost, and more potential for decreased reliability and increased manufacturing failures. Therefore, a need exists for highly integrated devices having all circuitry in one partition. For example, in the field of RF communication devices, there is a need for a highly integrated RF apparatus that includes a complete radio in one partition, die, IC, etc.

One approach to minimize interference is to keep interfering circuitry from operating at the same time. For example, where a processor interferes with analog circuitry, one approach would be to disable the processor whenever the analog circuitry is operating. However, this solution reduces the average available instructions per second (IPS) from the processor. Therefore, a need also exists for techniques which can manage system degradation through interference management and mitigation that also maximize the available processing power.

### SUMMARY OF THE INVENTION

This invention contemplates highly integrated apparatus and associated methods. In one embodiment, an apparatus includes analog circuitry configured to communicate using analog signals, digital circuitry, and a clock circuit for providing a clock signal to the digital circuitry, wherein the frequency of the clock signal is varied in such a way that interference between the digital circuitry and the analog circuitry is reduced.

Other features and advantages of the present invention will be apparent from the accompanying drawings and from the detailed description that follows below.

### BRIEF DESCRIPTION OF THE DRAWINGS

The present invention is illustrated by way of example and not limitation in the figures of the accompanying drawings, in which like references indicate similar elements and in which:

FIG. 1 is a block diagram of a mobile communication apparatus.

FIG. 2 shows a timing diagram illustrating a set of events in a TDI system.

FIG. 3 is a block diagram of a TDI capable mobile communication apparatus.

FIG. 4 is a flowchart illustrating a process for determining whether TDI can be at least partially disabled.

FIG. 5 is a flowchart illustrating a process for controlling the degree of interference caused by one or more physically distributed circuitry.

FIG. 6 is a simplified block diagram of one example of a regulator that that can be selectively changed from a switching regulator to a linear regulator.

FIG. 7 is a flowchart illustrating a process for altering the functionality of a circuit to change the spectral characteristics and/or the level of interference caused by the circuit.

FIG. 8 is a timing diagram illustrates a set of events in a TDI system including a limited processing time during RF time-slots.

FIG. 9 is a timing diagram illustrates a set of events in a TDI system including a limited processing time during RF time-slots.

FIG. 10 is a block diagram of a processor and associated buffer and clock circuitry.

FIG. 11 is a flowchart illustrating a process for reducing interference caused by a processor.

FIG. 12 is a diagram of a linear feedback shift register, used to generate a pseudo-random sequence.

FIG. 13 is a timing diagram illustrating one example of generating a modified clock signal having a frequency based on a pseudo-random sequence.

FIG. 14 is a diagram of a clock gating circuit.

### DETAILED DESCRIPTION

This invention relates to highly integrated sensitive analog systems (such as radio-frequency or RF systems) and digital systems. In one application of the invention, the concepts described below increase the processing power available for highly integrated systems. In one exemplary embodiment of the present invention, in a communication system, RF circuitry and signal-processing circuitry (e.g., digital signal processor (DSP), microprocessor, microcontroller, general-purpose logic circuitry, and the like) may reside in the same circuit partition, while interference is minimized and processing power is maximized. In one example, the RF circuitry and signal-processing circuitry reside on a package, such as a multi-chip module, integrated circuit, etc. Of course, the present invention may be used with any other desired system or device. Note that, while it is usually desirable to reduce interference, one goal is to adjust the characteristics of the interference so as to reduce the degradation to various measured metrics of signal quality (both in transmit and receive spectrums). The measured metrics of signal quality referenced above can include any desired metrics, such as signal strength, bit error rate (BER), noise floor, signal to noise ratio (SNR), signal to noise and distortion ratio (SINAD), phase jitter, phase noise, carrier power, modulation characteristics, latency (delay), total harmonic distortion (THD), bandwidth, spectral purity, margin to the transmit modulation mask, spurious emissions, etc. It is possible, for example, that a high level of interference can be tolerated at one frequency, but very little interference can be tolerated at another frequency. In some examples, the frequency of the interference can be shifted from a sensitive frequency to a less sensitive frequency (i.e., a frequency where more interference can be tolerated), if this shifting results in a higher quality signal.

Generally, in one example, the present invention relates to time-domain isolation (TDI) of different parts of an apparatus (e.g., isolating RF circuitry from digital circuitry in time). In an example of a communication system having signal processing circuitry and RF circuitry, the RF circuitry generally operates when the signal-processing circuitry is inactive, and vice-versa. As a consequence, the digital switching noise and associated harmonic content do not interfere with the performance of the RF circuitry, and vice-versa. The techniques described below allow at least limited use of signal processing and other digital circuitry while the RF circuitry is operating.

In order to provide a context for understanding this description, the following description illustrates one example of an environment in which the present invention may be used. Of course, the invention may also be used in many other types of environments Techniques of the present invention maybe used for any desired applications, including a wireless transmission system such as mobile or cellular communication devices or other wireless devices. Examples of systems where the present invention may be used include, but are not limited to, GSM, GPRS, EDGE, TDMA, PCS, DCS, or any similarly configured communication system.

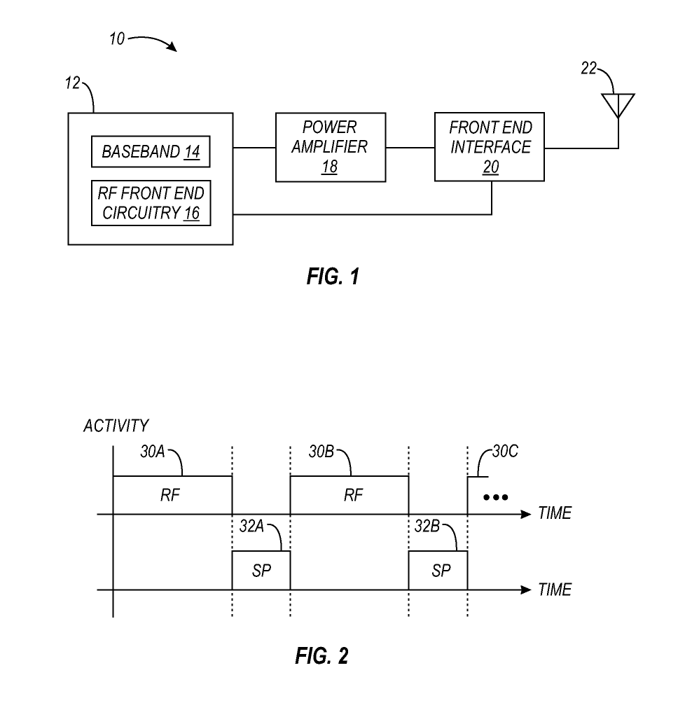

FIG. 1 is a block diagram of a mobile communication apparatus 10. Note that FIG. 1 shows the apparatus 10 generally, and that such an apparatus will include various other components, as persons of ordinary skill in the art who have the benefit of the description of the invention understand. The apparatus 10 shown in FIG. 1 includes a circuit partition 12 (e.g., an integrated circuit (IC), die, multi-chip module, package, system on a chip (SOC), EMI cavity, etc.), including a baseband 14 and RF front-end circuitry 16 (as well as other digital and RF circuitry ). The baseband 14 generally functions to control the operation of the apparatus 10, and may include microcontroller, digital signal processors, logic circuits, memory, etc. A processor or controller may be comprised of multiple processors, i.e., a plurality of processing elements. The RF front-end circuitry 16 generally provides an interface to a power amplifier 18 (to facilitate the transmission of signals) and front-end interface 20 (for the routing of signals to and from the antenna). The RF front-end circuitry 16 may provide reception functionality, transmission functionality, or both (i.e., transceiver functionality). Of course, the circuit partition 12 includes various other digital and RF circuitry (some of which is described below), as persons of ordinary skill in the art who have the benefit of the description of the invention understand. When transmitting signals, the power amplifier 18 provides amplified signals to the front-end interface 20, which then provides the amplified signals to the antenna 22. When receiving signals, signals are received by the antenna 22, and sent to the RF front-end circuitry 16 via the front-end interface 20.

The present invention may be applied to TDI systems, where the system typically alternates between either processing signals while RF circuitry is disabled (e.g., between transmit and receive slots) or disabling processing functions while the RF circuitry is enabled, to reduce potential interference between digital circuitry and RF circuitry. The present invention provides techniques that allow at least some processing capacity while the RF circuitry is activated. To help with the understanding of the context of the present invention, more detail about a TDI system is described below.

FIG. 2 is a timing diagram that illustrates a set of events that occur in a general communication system implementing time domain isolation. The example shown in FIG. 2 relates to a system that operates according to a TDMA protocol. As an example, two alternate events take place in this example: RF reception and/or transmission (RF), and signal processing (SP). In other words, the system arranges in time the reception and/or transmission activities and the signal-processing activities so as to avoid or reduce interference between the RF circuitry and the digital signal-processing circuitry.

Referring to FIG. 2, communication systems or apparatus according to exemplary embodiments of the invention use a plurality of RF time-slots 30A, 30B, 30C, and so on. Such systems or apparatus also employ a plurality of signal-processing time-slots 32A, 32B, and so on. Generally, during RF time-slots 30A-30C, the system or apparatus (e.g., the RF front-end circuitry 16 shown in FIG. 1) may receive RF signals or transmit RF signals, process the received signals, and perform any other desired manipulation of the data. Subsequently, during signal-processing time-slots 32A-32B, the system or apparatus (e.g., the baseband 14) may perform signal-processing tasks.

Note that the signal-processing tasks performed during signal-processing time-slots 32A-32B constitute various signal-processing functions in an RF communication apparatus. Examples of such tasks include modulation, coding, decoding, and the like. Also note that depending on the specific protocol, architecture, and circuitry used, the system or apparatus may receive and transmit simultaneously, as desired. Typically, though, the system either transmits signals or receives signals during any of the RF time-slots, or in bursts. For example, a GSM-compliant system or apparatus, such as a mobile telephone, either receives or transmits RF signals in one or more bursts of activity during RF time-slots. Note that the RF and signal processing time-slots can overlap or otherwise vary from that shown in FIG. 2. Also, the positions of the RF or signal processing time-slots in a GSM frame may change over time.

Note that the RF time-slots 30A-30C shown in FIG. 2 may have the same or different durations, as desired. Generally, the RF time-slots 30A-30C may have unequal lengths so as to accommodate a wide variety of circuitry, systems, protocols, and specifications, as desired. Each of the RF time-slots 30A-30C may include several other time-slots or a frame, depending on the particular communication protocol or technique used. For example, in a GSM application, each RF period may include a GSM slot, multiple slots, or multiple frames used to transmit, receive, or monitor.

Similarly, the signal-processing time-slots 32A-32B shown in FIG. 2 may have similar or dissimilar durations, as desired. Generally, the signal-processing time-slots may have unequal lengths so as to accommodate a broad array of signal-processing apparatus, circuitry, algorithms, and processing techniques. Each of signal-processing time-slots 32A-32B may include several other time-slots or time divisions, depending on the particular communication protocol and/or signal-processing techniques and the particular circuitry and technology used. For example, a signal-processing time-slot may include several time-slots, with a portion of a particular circuitry active or processing signals during one or more of the time-slots.

Furthermore, the signal-processing tasks may be performed in a serial or multiplexed manner (e.g., by sharing hardware to perform a variety of tasks), in a parallel manner (e.g., by using dedicated hardware for each signal-processing task), or in a combination of the two techniques, as desired. The choice of signal-processing hardware, firmware, and software depends on the design and performance specifications for a given desired implementation, as persons of ordinary skill in the art who have the benefit of the description of the invention understand.

To accomplish the isolation illustrated in FIG. 2, the RF circuitry and the signal-processing circuitry can be activated and deactivated, in correspondence with transitions from one time-slot to another. The activation and deactivation may be accomplished in a variety of ways. As mentioned above, the present invention teaches techniques for allowing at least some processing and other digital tasks to be accomplished during the RF receive/transmit times, such as during RF time-slots 30A-30C shown in FIG. 2.

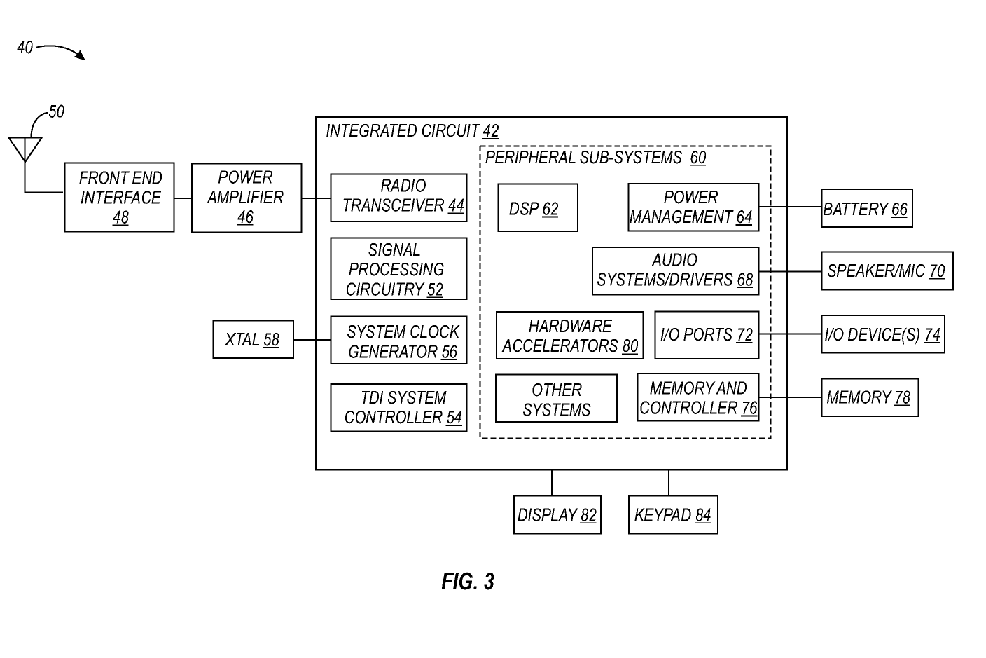

FIG. 3 is a block diagram of a TDI capable mobile communication apparatus 40, similar to the mobile communication apparatus shown in FIG. 1. Like FIG. 1, FIG. 3 shows the apparatus 40 generally. Such an apparatus will include various other components, as persons of ordinary skill in the art who have the benefit of this description will understand. The apparatus 40 shown in FIG. 3 includes an integrated circuit 42. The integrated circuit 42 includes a radio transceiver 44, which provides reception and transmission functionality. The radio transceiver 44 generally provides an interface to a power amplifier 46 (to facilitate the transmission of signals), which is coupled to front-end interface 48 (for the routing of signals to and from an antenna 50). When transmitting signals, the power amplifier 46 provides amplified signals to the front-end interface 48, which then provides the amplified signals to the antenna 50. When receiving signals, signals are received by the antenna 50, and sent to the radio transceiver 44 via the front-end interface 48.

The integrated circuit 42 shown in FIG. 3 also includes signal processing circuitry 52 for processing signals, as needed. A TDI system controller 54 is used to control the TDI functionality of the integrated circuit 42, including functions such as enabling and disabling various circuitry, as well as controlling the operations and functions described below. The integrated circuit 42 includes a system clock generator 56, which generates one or more clock signals for use by various components of the integrated circuit 42. In this example, the system clock generator 56 uses an external crystal oscillator 58 for generating clock signal(s).

FIG. 3 also shows a plurality of exemplary peripheral sub-systems 60 of the integrated circuit 42 (illustrated by the dashed line). The integrated circuit 42 may also include various other peripheral sub-systems in addition to the ones shown, as one skilled in the art would understand. A digital signal processor (DSP) 62 is used for providing general digital signal-processing functions. Power management circuitry 64 is coupled to an external battery 66, and provides and manages power to various components of the integrated circuit 42. Audio systems circuitry 68 and corresponding audio drivers are coupled to external audio devices, such as a speaker and microphone 70. The peripheral sub-systems 60 include one or more input/output (I/O) ports, which are configured to provide communications with I/O devices 74. Examples of I/O devices that could be coupled to I/O ports of the integrated circuit 42 include SIM cards, USB devices, infrared devices (IRDA), and any other desired devices. The peripheral sub-systems 60 also include memory and/or a memory controller 76. The integrated circuit 42 may utilize internal memory, as well as external memory 78, as desired. The peripheral sub-systems 60 may also include one or more hardware accelerators 80 for speeding up the processing of certain operations. FIG. 3 also shows a display 82 and keypad 84 coupled to the integrated circuit 42. Display 82 provides text, image, graphic, and similar information to the user. Keypad 84 allows the user to enter symbols, such as alphanumeric symbols.

The present invention relates to techniques that allow at least limited use of signal processing and other digital circuitry while the RF circuitry is operating in a TDI enabled RF apparatus, such as that shown in FIGS. 1 and 3. The invention is useful in integrated transceiver communication systems where intensive signal processing and chip I/O activity (activities that may cause interference with other components) are desired while maintaining a high performance radio link in time varying radio channel conditions. The present invention provides apparatus and methods by which the operation of various radio-interfering circuits can be altered or controlled to mitigate levels of interference to the radio link to acceptable levels based on current or predicted radio link requirements. As is described in more detail below, techniques may be used in response to varying channel conditions in real time and/or by using prior knowledge of known artifacts of the system architecture such as specific radio channel weaknesses, in order to maintain a required level of radio performance or a desired quality of the radio communications link.

One consideration when implementing the present invention relates to specific radio architecture designs. Typically, a given radio architecture will have performance sensitivities or limitations which are functions of the mode of operation of the radio. For example, it may be known that for a given radio architecture, certain radio frequency channels or the choice of the intermediate frequency (IF) in a low-IF or heterodyne receiver are susceptible to spectral interference at specific frequencies. This knowledge about a radio's architecture can be used to alter the spectral characteristics of interference radiated from other circuitry so that the resulting interference intentionally avoids the sensitive frequencies. In some examples, this may simply involve a change in frequency and/or functionality of one or more of the architectural parameters of the circuit (e.g. use a different IF to alter the characteristic susceptibility of the radio).

In some examples, the invention uses real-time information (e.g., see the exemplary signal quality metrics described above) regarding things such as radio link conditions, radio transmit and receive performance, signal processing requirements, etc., to allow at least some processing (or other tasks) during RF time-slots (FIG. 2) in TDI communication systems. When it is determined that the radio conditions are such that a certain amount of interference from a processor (or other noise-generating circuitry) can be tolerated, the present invention allows the processor (or other circuitry) to be at least partially enabled, either in a normal manner or in some modified manner. While various examples are described below, one skilled in the art will understand that various alternative techniques for determining radio conditions and controlling or altering the operation of circuitry are possible within the scope of the invention.

One example of a radio condition where some interference from a processor (or other circuitry) may be tolerated is when the signal received by the radio is relatively strong. This situation may occur when a mobile handset (or other wireless device) is in close proximity to a base station. If the received RF signal is strong enough, the effect of interference from a processor (or other circuitry) may be reduced. In some wireless applications, a receive signal strength indicator (RSSI) provides a real-time indication of the strength of a received signal. There are other more complex measures of received signal quality, such as BER or SNR for example, which one skilled in the art can understand to be similarly useful for the purposes of this invention. If the signal quality is sufficiently high, it may be acceptable to enable the signal processessing (SP) for a longer portion of time allocated to RF activity, and in the limiting case, it may be possible to fully disable TDI, (i.e., allowing full signal processing while the receiver is operating). Similarly, if the quality of the received signal is extremely poor, SP during RF can be scaled back accordingly with the limiting case of full TDI (i.e. minimal SP during RF allowed).

One example of how this can be implemented is to establish a RSSI threshold level. A threshold level can be determined by looking at radio conditions at various receive signal power levels. The threshold level can vary depending on other factors, such as the currently used channel (since different channels may be affected differently by interference from any given interference source). By comparing the RSSI level with the RSSI threshold level, it can be determined whether TDI can be disabled. If so, and if tasks are available and waiting to be processed, at least some of the tasks can be processed during an RF time-slot.

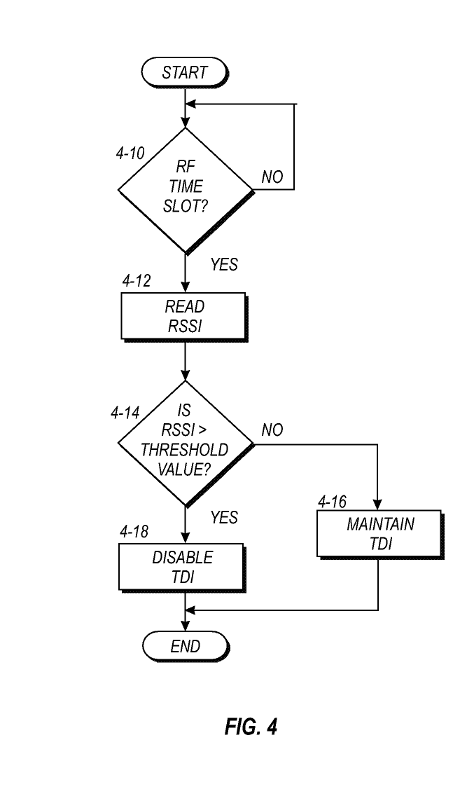

FIG. 4 is a flowchart illustrating a process for determining whether TDI can be at least partially disabled. The process illustrated in FIG. 4 begins with step 4-10, where the process waits for an RF timeslot. At step 4-12, the RSSI is read, which will provide an indication of the strength of a received RF signal. At step 4-14, the process determines whether the read RSSI is above the previously established threshold value. Note that, multiple threshold values may be used, where other conditions in the radio may warrant different threshold levels (e.g., different channels, etc.). If the RSSI is below the threshold value, the process proceeds to step 4-16, and normal TDI operation is maintained. If the RSSI is greater than the threshold value, the process proceeds to step 4-18, and TDI operation is disabled, and the processor (or other circuitry) is allowed to operate during the RF time-slot. The process illustrated in FIG. 4 (as well as the subsequently described processes) may continuously repeat, may restart at the beginning of each time-slot, or may restart at the beginning of each RF time-slot, as desired.

The process described above also applies while transmitting signals. In this case, a transmit power threshold is established such that a processor (or other circuitry) is allowed to operate if for example, there are processing tasks pending, and the conditions are such that the level of interference imposed on the transmit circuitry by the processor is determined to be an acceptable level of interference by some measure of quality (e.g. spectral purity or phase noise of the carrier, margin to the transmit modulation mask, spurious emissions, etc.). This determination can be done in real-time, or ahead of time depending on the specification or application of the device which is understandable by someone skilled in the art.

The present invention also includes techniques for altering the spectral characteristics of processor signals (or other signals) based on radio and transmit/receive signal qualities and/or link conditions. These alterations of the characteristics of the signal processing ensure that no more than an acceptable amount of interference at frequencies of susceptibility or otherwise is allowed during instances where TDI is being waived (i.e., where the processor and sensitive analog radio circuitry are allowed to operate at the same time). There are numerous ways to alter the spectral characteristics of the interference from signal processing circuitry, and in general, from digital or otherwise electrically noisy circuitry as one skilled in the art would understand. Following are several examples. Note that numerous other examples are possible within the spirit and scope of the invention.

One example of a technique for altering the spectral characteristics of a signal processor (or other clocked circuitry) relates to physically distributed circuitry (or more generally, distinctly controllable peripheral circuit functions) on an integrated circuit. When a signal processor has various distributed circuitry (e.g., I/O ports, hardware accelerators, etc.) one way to control the degree of interference between the signal processor and radio circuitry is to apply limits on signal processor functionality. This control can be based on the real-time (or predicted) radio conditions, signal quality, or other as was explained earlier. Some examples of distributed circuitry is shown in FIG. 3, including I/O ports 72, hardware accelerators 80, and memory and/or memory controller 76. Possible limitations that can be put on such circuitry that will reduce the degree of interference caused by the circuitry, will be apparent to one skilled in the art having the benefit of this description. For example, assume that a certain active I/O port contributes significantly more interference to radio performance than a certain hardware accelerator. In this example, under favorable radio link conditions, the I/O port and hardware accelerator can be made available to the signal processor. If radio link conditions worsened (e.g., signal strength reduced) the higher interfering function (in this example, the I/O port) can be disabled, while the lower interfering function (in this example, the hardware accelerator) may be allowed to operate. If radio link conditions worsened further, the hardware accelerator may also be disabled. Likewise, as radio link conditions improve, more distributed circuitry (or peripheral sub-subsystems) can be enabled.

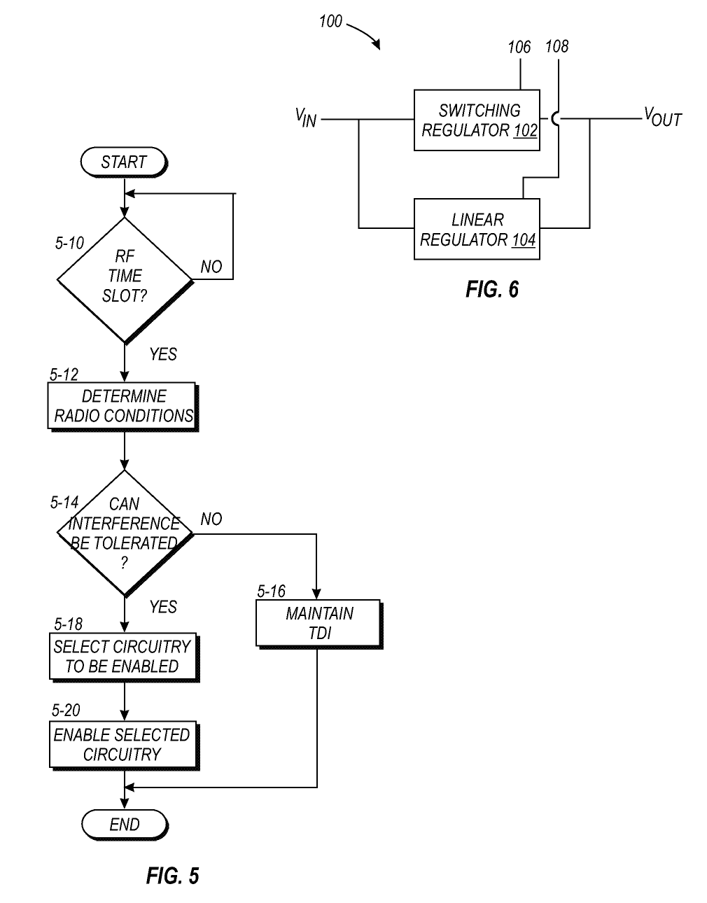

FIG. 5 is a flowchart illustrating a process for controlling the degree of interference caused by one or more physically distributed circuitry. The process illustrated in FIG. 5 begins with step 5-10, where the process waits for an RF time-slot. At step 5-12, the process determines the radio link conditions or signal qualities (e.g., based on measured or predicted conditions). For example, the processor might determine the strength of a received RF signal, a condition relating to the currently used channel, or a condition relating to a known artifact of the apparatus as described earlier in other examples relating to signal quality. Other examples are also possible, where the RF time-slot can be taken to mean any point in time where the sensitive analog circuitry is enabled and it's performance is critical as one skilled in the art would understand. At step 5-14, the process determines whether interference can be tolerated, based on the determined radio conditions (e.g. link, quality, etc.). If no more interference can be tolerated, the process proceeds to step 5-16, and normal TDI operation is maintained. If a certain amount of interference can be tolerated, the process proceeds to step 5-18, and an algorithm is used to select one or more distributed circuitry to be enabled. This selection can be accomplished in any desired manner. In one example, a plurality of distributed circuitry are prioritized based on the amount of interference they would cause if enabled, and the circuitry are selected based on priority. In another example, a plurality of distributed circuitry are prioritized based on factors such as the circuitry's importance. Finally, at step 5-20, the selected distributed circuitry is enabled to operate during the RF time-slot.

In another example, where a signal processor includes a DSP and an application processor, for example, various entire processor functions can be selectively enabled or disabled for use during times when the radio is active, based on current radio conditions, signal qualities, and signal processing requirements.

Another example of a technique for altering the spectral characteristics of a signal processor (or other clocked, or non-clocked digital circuitry) relates to altering the functionality of various circuitry in the apparatus. In this example, the circuitry is altered such that the amount of interference that it causes is reduced, and/or the spectral characteristics of interference caused by the circuitry changes in a way that allows it to operate during an RF time-slot, where it otherwise might degrade the performance (by measure of link condition, or signal quality) of the radio to unacceptable levels.

One example of how the functionality of a circuit can be altered to change its level of interference relates to power regulators. A power management unit (e.g., see power management block 64 in FIG. 3) typically will include a regulator for providing a regulated voltage to a circuit. In the example shown in FIG. 3, the power management block 64 includes a regulator for providing a regulated voltage source to the integrated circuit 42. Normally, it is desired to design circuitry that is efficient and small. In the example of regulators, a switching regulator design (i.e., a switched-mode power supply) typically provides an efficient way of regulating a voltage. A typical switching regulator uses an internal control circuit that switches the load current rapidly on and off in order to stabilize the output voltage to a desired voltage. However, the high frequency switching can cause interference in other circuitry, such as with the radio in an RF apparatus. During a signal processing time-slot (e.g., slots 32A, 32B, etc. in FIG. 2), the high frequency switching is not a problem, since the radio is not operating during the signal processing time-slots. In contrast to a switching regulator, a linear regulator will produce less high frequency interference, but will be less efficient. By altering the functionality of a power regulator from a switching mode of operation to a linear mode of operation, the regulator may cause a small enough amount of interference that it can be operated during an RF time-slot. In the linear mode of operation, the regulation efficiency will typically be poorer than in the switching mode of operation, so it is beneficial to operate the regulator in the linear mode of operation only when necessary, based on the radio characteristics, signal conditions, the radio architecture, the transmit or receive channel being used, etc.

FIG. 6 is a simplified block diagram of one example of a regulator that that can be selectively changed from a switching mode of operation to a linear mode of operation. By switching the functionality of the regulator from a switching mode to a linear mode of operation, spurious energy associated with the switching clock frequency can be eliminated. FIG. 6 shows a regulating circuit 100 that includes switching regulator circuitry 102 and linear regulator circuitry 104. The switching regulator circuitry 102 and linear regulator circuitry 104 are coupled to an input voltage V_{IN} and generate a regulated output voltage V_{OUT}. Control signals 106 and 108 are used to selectively enable and disable the switching regulator circuitry 102 and linear regulator circuitry 104, such that, the RF apparatus can select whether the regulator circuitry 100 operates in a switching mode (more efficient, but generating more interference) or a linear mode (less efficient, but generating less interference). Other examples of altering the functionality of a circuit are also possible.

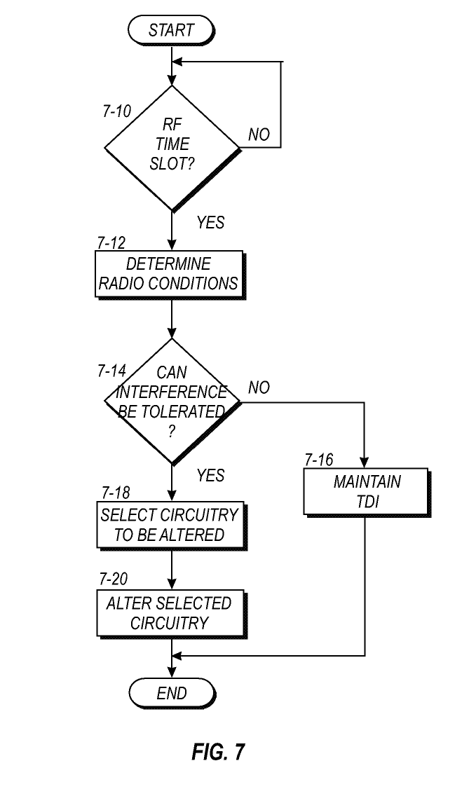

FIG. 7 is a flowchart illustrating a process for altering the functionality of a circuit to change the spectral characteristics and/or the level of interference caused by the circuit to reduce the degradation in performance of the analog circuitry (i.e. as measured by the link conditions or signal quality as described earlier for the RF circuit in this example). The process illustrated in FIG. 7 begins with step 7-10, where the process waits for an RF time-slot. At step 7-12, the process determines the radio link conditions or signal quality (e.g., based on measured or predicted conditions). For example, the process might determine the strength of a received or transmitted RF signal, a condition relating to the currently used channel, or a condition relating to a known artifact of the apparatus. Other examples are also possible as described earlier. At step 7-14, the process determines whether an increased level of interference or an altered spectral characteristic of the interference can be tolerated. If it cannot, or if there is no benefit to doing so, then the process proceeds to step 7-16, and the current mode of TDI operation and interference levels or characteristics is maintained. If however, a different amount of interference or interference characteristic than is currently being tolerated can be tolerated, and there is a material benefit in doing so (e.g. increased SP capability, peripheral functions, improved power efficiency, etc.), then the process proceeds to step 7-18, and an algorithm is used to select one or more circuits to have its functionality altered. An example of how the functionality of a circuit can be altered is given above (FIG. 6). This selection can be accomplished in any desired manner. Finally, at step 7-20, the functionality of the selected circuit is altered. In the example given above, at step 7-20, the regulator is altered to operate in a linear mode of operation during the RF time-slot.

One example of a technique for altering the spectral characteristics of a signal processor (or other clocked circuitry) is to use algorithms that are designed to have modes of operation which have altered spectral characteristics from an interference point of view. For example, if during a transmitting or receiving operation, it is required that information be communicated digitally, either between circuits on the integrated circuit (e.g., between internal RAM and a processor) or between circuitry on the integrated circuit and circuitry external to the integrated circuit via an I/O interface, it is possible to extend the concepts of spectral characteristic shaping to that of an algorithm. For example, external memory access (read and write) can be performed in ways (e.g. using a specific time-domain pattern) which reduces interference at certain frequencies, or which tend to spread interference across a broader spectrum to lower peak levels at any given frequency. Since such an effort would typically come with some performance overhead (e.g., instruction count, power dissipation, complexity), real-time radio conditions would dictate when such action is necessary to maintain a desired level of radio performance.

Other examples of techniques for altering the spectral characteristics of a signal processor (or other clocked circuitry) relate to clocking signals. One technique for altering the spectral characteristics of a signal processor is to modify the processor clocking signal to cause the spectral characteristics of the signal processor to change. By knowing the characteristics of the radio (e.g., knowing what frequencies will cause interference problems), desired results can be achieved by modifying clock signals. Several examples of modified clock signals are described below.

One way to modify the clocking signal is to vary the duty cycle of the signal processing enabled during RF by gating the clock signal. For example, it may be desired that, under the most unfavorable radio link conditions, or signal quality (i.e., conditions are such that it is desired to minimize interference), the signal processor be allowed to operate for a very small portion of the RF time-slot duration. This can be accomplished by providing a signal processing clocking signal for a very small fraction of the time during RF. As radio link conditions improve (e.g., as the received RF signal strength increases, etc.), the signal processor may be allowed to process more instructions during the RF time-slot (by increasing the period of time during RF for which the signal processing clock signal is active). This may effectively increase the amount of interference from the signal processor, but since the radio link conditions have improved, more interference can be tolerated. In another example, signals are allowed to be processed during one of every N RF time-slots (e.g., if N=4, the processor is enabled every fourth RF timeslot, and disabled for the remainder of the RF time-slots).

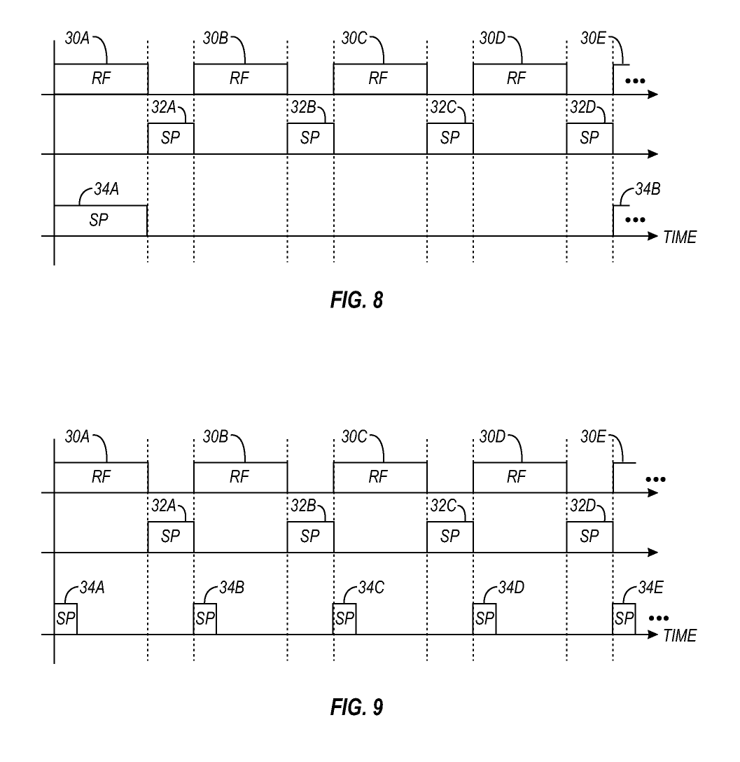

FIG. 8 is a timing diagram similar to FIG. 2 that illustrates a set of events that occur in a general communication system implementing time domain isolation. Like in FIG. 2, FIG. 8 shows that two events take place in this example: RF reception and/or transmission (RF), and signal processing (SP). In other words, the system arranges in time the reception and/or transmission activities (i.e. sensitive analog activities) and the signal-processing (e.g. digital or similar interference generating) activities (in the top two lines) so as to avoid, reduce, or control the interference between the RF circuitry and the digital signal-processing circuitry. Referring to FIG. 8, communication systems or apparatus according to exemplary embodiments of the invention use a plurality of RF time-slots 30A, 30B, 30C, and so on. Such systems or apparatus also employ a plurality of signal-processing time-slots 32A, 32B, and so on. Generally, during RF time-slots 30A-30C, the system or apparatus (e.g., the RF front-end circuitry 16 shown in FIG. 1) may receive RF signals or transmit RF signals, process the received signals, and perform any other desired manipulation of the data. Subsequently, during signal-processing time-slots 32A-32B, the system or apparatus (e.g., the baseband 14) may perform signal-processing tasks. FIG. 8 shows a third line, representing signal processing that is allowed to occur during the RF time-slots 30A, 30E, and so on. As shown, in this example, signal processing (labeled 34A, 34B, and so on) is allowed to occur during every fourth RF time-slot (30A, 30E, and so on). Since the signal processing is only allowed during one of every four RF time-slots 30A, there will be less average interference caused by the signal processor than there would be if the signal processor were enabled during every RF time-slot.

In another example, signals are allowed to be processed during 1/N of each RF time-slot (e.g., if N=4, the processor is enabled for ¼ of every RF time-slot, and disabled for the remainder of each RF time-slot).

FIG. 9 is a timing diagram similar to FIG. 8 that illustrates a set of events that occur in a general communication system implementing time domain isolation. Like in FIG. 8, FIG. 9 shows that two events take place in this example: RF reception and/or transmission (RF), and signal processing (SP). In other words, the system arranges in time the reception and/or transmission activities and the signal-processing activities so as to avoid or reduce interference between the RF circuitry and the digital signal-processing circuitry. Referring to FIG. 9, communication systems or apparatus according to exemplary embodiments of the invention use a plurality of RF time-slots 30A, 30B, 30C, and so on. Such systems or apparatus also employ a plurality of signal-processing time-slots 32A, 32B, and so on. Generally, during RF time-slots 30A-30E, the system or apparatus (e.g., the RF front-end circuitry 16 shown in FIG. 1) may receive RF signals or transmit RF signals, process the received signals, and perform any other desired manipulation of the data. Subsequently, during signal-processing time-slots 32A-32D, the system or apparatus (e.g., the baseband 14) may perform signal-processing tasks. FIG. 9 shows a third line, representing signal processing that is allowed to occur during every RF time-slot 30A, 30B, 30C, and so on. As shown, in this example, signal processing (labeled 34A, 34B, 34C and so on) is allowed to occur during every RF time-slot (30A, 30B, 30C, and so on), but only for ¼ of each time-slot. Since the signal processing is only allowed during ¼ of each RF time-slot, there will less interference caused by the signal processor than there would be if the signal processor were enabled for the entirety of every RF time-slot. Note that the signal processing 34A, 34B, etc., can occur at any desired time during each RF time-slot.

In another example, signals are allowed to be processed during a portion of an RF time-slot where a higher level of interference or a certain characteristic interference can be tolerated with less degradation to important measures of signal quality or performance (e.g., the processor is enabled during the portion of a receive burst in a GSM system where frequency error correction is being performed, and is disabled for the remainder of the burst when bit-error rate performance is most important and most susceptible to SP interference). These same techniques apply to other circuitry as well. For example, memory access during an RF time-slot can also be limited to specific times in the RF time-slot or can be limited to a limited number of RF time-slots and limited portion of that RF time-slot (e.g., memory access is allowed during every fourth RF timeslot, during less sensitive moments in time, and is disabled for the remainder of the RF time-slots).

The present invention also includes techniques for minimizing interference by manipulating the clock signal that clocks one or more processors (e.g., DSP, microcontroller unit (MCU), etc.) in an RF system, where an RF system is understood to be a highly integrated system with both sensitive analog circuitry and signal processing circuitry where due to the proximity of the various circuit partitions, there is electrical and magnetic coupling between partitions. This coupling can degrade the performance of the sensitive analog circuitry as has been described throughout this description of the invention). To help understand the techniques described below, it is helpful to understand the source of some of the interference present in an RF system. For RF systems with multiple channels spanning large frequency ranges, it can be difficult to keep spurs (i.e. highly tonal and usually higher amplitude characteristics of the frequency spectrum of the interference) out of the transmit and receive frequency bands. This is especially difficult in systems integrated on a single integrated circuit, where RF analog circuitry resides on the same substrate as processors and other digital circuitry.

Spurs typically occur at multiples of clock signal frequencies. For example, in a Global System for Mobile Communications (GSM) compliant system, spurs typically occur at multiples of a 13 MHz or 26 MHz clock, since the signaling and framing in GSM is based on a 13 MHz or 26 MHz system clock. If there is substantial digital activity at multiples of the 13 MHz clock (e.g., 130 MHz or 156 MHz), spurs may occur at harmonics of the higher multiple clock. For example, GSM channel 5 lies at 936 MHz, which is 156 MHz*6, or 26 MHz*36. Therefore, in this example, digital activity at 26 MHz will create a spur at 936 MHz, as will activity at 156 MHz. Note that these are merely examples, and the present invention may be used in any desired application, based on any standard.

As mentioned, one example of a technique for reducing interference (spurs) is to manipulate the frequency of clock signals used to clock one or more processors. For example, in an example where a processor normally runs at 156 MHz, instead of using a 156 MHz clock, a 130 MHz could be used during times when RF activity is being performed on a channel at 156*N MHz. However, note that the 130 MHz and 156 MHz modes may have subsystems that operate at a common divisor of 26 MHz, so both frequencies may generate spurs at frequencies 26*N MHz.

Another example of a technique for reducing interference that is related to system clock frequencies is to use a clock signal that is non-fixed, preferably using a small, quiet circuit to generate the clock signal. In one example, a non-fixed clock signal can be generated that hops through a sequence of clock periods, or through a sequence of instantaneous frequencies. For example, starting with a relatively high frequency, such as 156 MHz, the clock generation circuit can use a pseudo-random sequence of periods of 1*T, 2*T, 3*T, 4*T, . . . M*T, where the period T=1/156 MHz and M are chosen to give enough flexibility to sufficiently lower the generated spur to a satisfactory level.

Some circuits are designed to operate using precise clock signals. However, much digital logic, such as a DSP, can operate using a pseudo-random clock with the circuitry configured to accommodate a non-precise clock signal. In one example, buffer circuitry is coupled to the data inputs and/or data outputs of a processor. The function of the buffer circuitry is to buffer data that is received by the processor, or transmitted by the processor. The rate of flow of data into or out of the processor may have to remain constant, despite the fact that the processor is being clocked at a non-precise (e.g., pseudo-random) frequency. For example, in the example of a radio application, data received by the radio is received in real-time, and the processor must processes the data as it is received. If the data is first received by a buffer, and then sent to the processor as the processor is ready for the data, the flow of data can be maintained. For example, during times when the processor is being clocked in such a way that it can not keep up with the flow of data, the buffer will store the received data until such time that the processor is capable of processing it. Likewise, for output data (i.e., data being sent by the processor) a buffer can store the data during times that the processor is outputting data faster than the associated circuitry expects it.

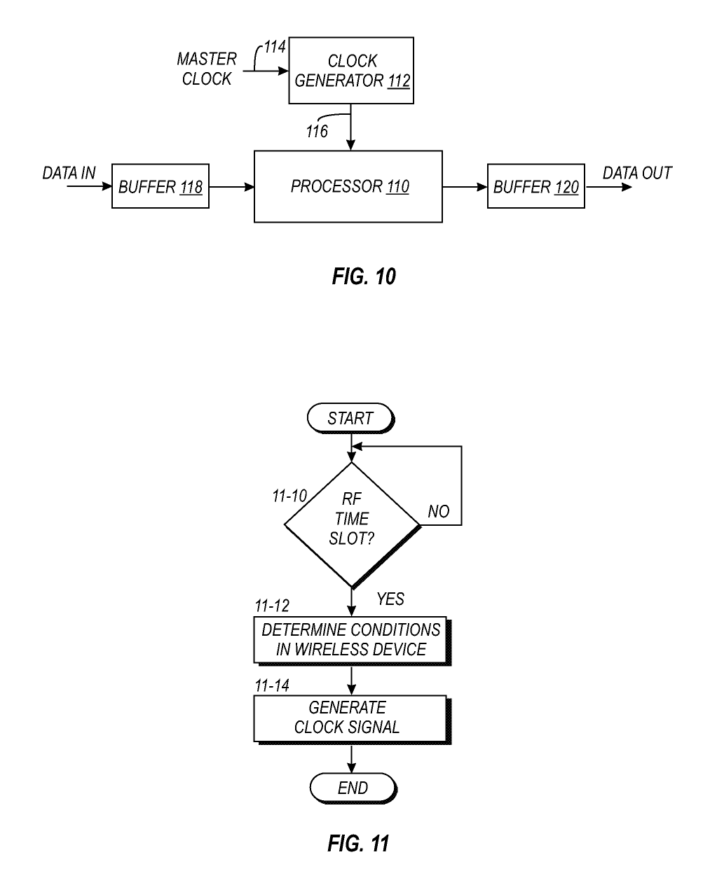

FIG. 10 is a block diagram of a processor and associated buffer and clock circuitry. FIG. 10 shows a processor 110 and clock circuitry 112. The clock circuitry takes a master clock signal 114, and generates a modified clock signal 116. The modified clock signal may be a precise clock signal with a frequency different from the frequency of the master clock signal 114, or may be a non-precise clock signal, which spreads the frequency spectrum of interference caused by the processor. In one example, the clock circuitry 112 generates a modified clock signal 116 that hops through a pseudo-random sequence of clock periods (described in detail below). In another example, the clock circuitry 112 can generate modified clock signals 116, which have frequencies that are divisors of the frequency (f_{MC}) of the master clock (e.g., f_{MC}/2, f_{MC}/3, f_{MC}/4, f_{MC}/5, f_{MC}/6, and so on). Of course, various other types of modified clock signals may also be used. For any particular application, the clock circuitry 112 is configured in such a way that the frequency or frequencies of the modified clock signal 116 tend to adjust the spectral characteristics of interference caused by the processor 110. This will result in less interference, a frequency shifting of the interference, or both.

FIG. 10 also shows buffer circuitry at the input (buffer 118) and output (buffer 120) of the processor 110. For data being received by the processor 110 (DATA IN), the buffer 118 will store the data during times that the processor 110 is being clocked too slow to keep up with the flow of data. This way, the flow of data into the processor 110 from other circuits can be maintained at all times. Similarly, for data being outputted by the processor 110 (DATA OUT), the buffer 120 will store the data during times that the processor 110 is being clocked fast enough that the output of data from the processor 110 is sent at a rate faster than expected by the other circuitry.

FIG. 11 is a flowchart illustrating a process for reducing interference caused by a processor by manipulating the clock signal that clocks a processor. The process illustrated in FIG. 11 begins with step 11-10, where the process waits for an RF timeslot (described above). At step 11-12, one or more conditions of the wireless device are determined. Any desired conditions can be used by the process. Examples of conditions include, but are not limited to, various radio link conditions, the currently used channel, receive signal quality (e.g., signal to noise ratio, BER, noise floor, some other metric, etc.), transmit signal quality (e.g., transmission spectrum, phase noise, carrier power, modulation characteristics, some other metric, etc.), signal strength, the receive frequency, the transmit frequency, some internal parameter (e.g., local oscillator frequency), processing requirements, known artifacts relating to the radio, etc., or any combination thereof. Next, at step 11-14, the clock generator circuitry generates a clock signal, which is used to clock the processor. As described above, the generated clock signal is generated in such a way that interference caused by the processor will be reduced, and/or shifted to frequencies where more noise can be tolerated. The clock signal generated at step 11-14 can be configured in any desired manner, as described above. For example, the generated clock signal may be constant or varying. A varying clock signal may change on a periodic basis (e.g., every N cycles, where N is an integer greater than zero), changed randomly, changed every clock cycle, etc. In another example, the frequency of the clock signal is changed periodically to frequencies determined by a pseudo-random sequence.

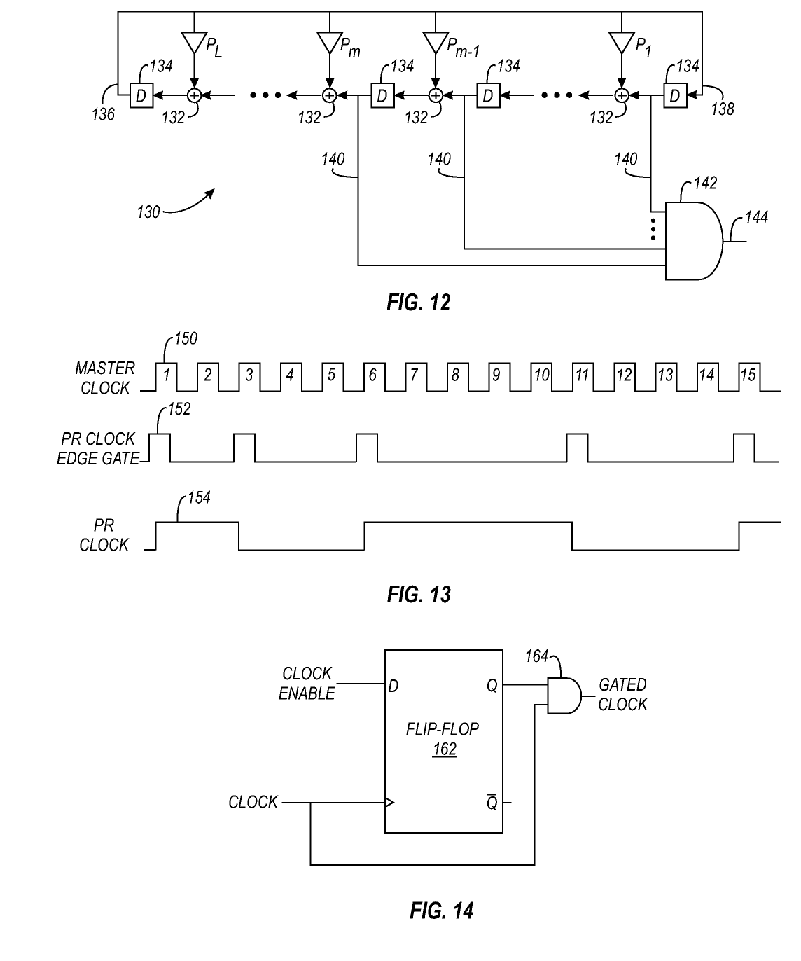

As mentioned above, in one example, the clock circuitry is configured to generate a clock signal that changes in frequencies that are determined by a pseudo-random sequence. Such a clock signal can be generated in any desired manner. In one example, the clock circuit uses a linear feedback shift register (LFSR) to generate a pseudo-random sequence, and a clock gating circuit to use the pseudo-random sequence to create a modified clock signal. FIG. 12 is a diagram of an exemplary LFSR 130, used to generate a pseudo-random sequence. Generally, the LFSR 30 is a bank of flip flops and exclusive OR (XOR) gates configured to generate a pseudo-random sequence of ones and zeros. FIG. 12 shows a plurality of XOR gates 132 coupled between a series of D-type flip-flops 134. In the example of FIG. 12, L XOR gates 132 and L+1 flip-flops 134 are used, where L is an integer. The output 136 of the shift register is fed back into the input 138 of the shift register. The output 136 is also provided to a plurality of polynomial functions (P₁, P₂, . . . P_{L}), whose outputs are provided to a corresponding XOR gate 132. Each XOR gate 132 mixes the output of the corresponding polynomial function with the output of the previous XOR gate 132. FIG. 12 also shows a plurality of taps 140 (in this example, m taps, where m is an integer) that are provided as inputs to AND gate 142. Generally, each tap 140 has a value of 1 or 0, with an equal probability of each value. The output of the AND gate 144 will be high whenever every tap is high, and will be low for every other combination of inputs. The output 144 can be thought of as a “weighted coin flip”. By selecting the number of taps 140, the probability of getting a high or low at the output 144 can be controlled. For example, with only one tap 140, there is a 50% chance (½) of a high signal. With two taps, there is a 25% chance (¼), and so on. The end result is that the output 144 of the AND gate 142 will be either high or low, depending on the states of the tap(s) 140. The pseudo-random sequence present at the output 144 can be used by clock circuitry to generate a modified clock for the processor.

FIG. 13 is a timing diagram illustrating one example of generating a modified clock signal having a frequency based on a pseudo-random sequence. As mentioned above, the goal is to spread the spectral (interference) energy of the digital circuitry during RF time-slots such that processors (and other digital circuitry) can operate during RF time-slots without significantly impairing spur frequencies. This is accomplished by randomly gating clock edges with the LFSR (described above). An over-clocked master clock signal 150 is used to give better resolution to the randomized clock edges. In one example, the master clock is chosen to be an integer multiple of the maximum processor clock.

For example, assume a processor has a maximum clock of 208 MHz. A master clock frequency could then be chosen to be 1040 MHz (5*208 MHz). In this example, each pseudo-random (PR) period (positive-edge to positive-edge, or negative-edge to negative-edge) must be at least 5 master clock periods, since the maximum frequency that the processor can handle is 208 MHz. Logic circuitry can specify that if the previous ½ period was 2 master clock periods, then the next ½ period should be at least 3 master clock periods. Similarly, if the previous ½ period was greater than 2 master clock periods, then the next ½ period should be at least 2 master clock periods. This ensures that the clock signal used to clock the processor remains less than or equal to 208 MHz.

Using the LFSR 130 described above, the lower “m” bits are used for the weighted coin flip. Hence, for a transition probability of ½, only one tap 140 would be used (m=1). For a probability of ¼, two taps 140 would be used (m=2), and so on. Table I is a table illustrating the correlation of the transition probabilities to the average pseudo-random clock frequency, using the example of a master clock of 1040 MHz and a maximum processor clock rate of 208 MHz.

TABLE I

| TRANSITION | AVERAGE PSEUDO-RANDOM |
|---|---|
| PROBABILITY | CLOCK FREQUENCY |
| ½ | 148.6 MHz |
| ¼ | 94.5 MHz |
| ⅛ | 54.7 MHz |
| 1/16 | 29.7 MHz |
| 1/32 | 15.5 MHz |

Referring again to FIG. 13, the master clock 150 is a clock signal having a frequency selected, as desired (in the example above, 1040 MHz). The pseudo-random clock edge gate signal 152 is a gated clock signal generated by requesting the state of the output 144 at any given time. In one example, a clock enable signal will be set high whenever the system needs a pseudo-random value from the LFSR 130. When the clock enable signal is high, and the master clock is high, the output of the clock gate circuitry (described below) will be high. The pseudo-random clock signal 154 (or, the modified clock signal 116 discussed above) will change states whenever the edge gate signal 152 is high. In the example shown in FIG. 13, each period of the master clock 150 has been labeled 1-15, for clarity. At master clock period 1, the edge gate signal is high, so the pseudo-random clock 154 goes high. At period 3, the edge gate signal 152 is high, so the pseudo-random clock 154 goes low. Recalling above that if the previous ½ period was 2 master clock periods long, the next rising edge of the pseudo-random clock 154 must be at least 3 master clock cycles away. Therefore, the system waits until period 6 to request a bit from the LFSR 130. In this example, the LFSR output 144 is high, so the pseudo-random clock 154 goes high. Since the previous ½ period was 3 master clock periods long, the system waits until period 8 to request a bit for the LFSR 130. At period 8, the output of the LFSR 130 is low, so the pseudo-random clock 154 remains high. This repeats until, at period 11, the output of the LFSR 130 is high, so the pseudo-random clock 154 goes low. This process continues as long as the pseudo-random clock 154 is needed. Referring to Table I, and the discussion above, it can be seen that, as the probably of a high state at the output 144 decreases, the average frequency of the pseudo-random clock 154 will also decrease.

FIG. 14 is a diagram of an exemplary clock gating circuit, which may be used with the present invention. As shown, the clock gating circuit has a clock enable signal that is provided to the input D of a D-type flip-flop 162. The output Q of the flip-flop 162 is coupled to one input of AND gate 164. The other input of the AND gate 164 is coupled to the clock signal that clocks the flip-flop 162. During operation, the output of the AND gate 164 (the gated clock) will change to the current value of the clock enable signal, whenever the flip-flop 162 is strobed. Referring back to FIG. 13, the edge gate signal 152 can be generated using a similar gate clock circuit.

Note that the pseudo-sequence generated by the LFSR 130 can be customized, as needed. At the start of operation, an LFSR can be seeded with values that will determine the pseudo-random sequence. Therefore, the pseudo-random sequence can be customized such that the sequence is tailored to achieve desired results for any given conditions. For example, in applications using various radio channels, various pseudo-random sequences can be customized for use with specific channels. During operation, the pseudo-random sequence that corresponds to the currently used channel will be used, to further improve the performance of the system.

In the preceding detailed description, the invention is described with reference to specific exemplary embodiments thereof. Various modifications and changes may be made thereto without departing from the broader spirit and scope of the invention as set forth in the claims. The specification and drawings are, accordingly, to be regarded in an illustrative rather than a restrictive sense.

What is claimed is:

1. An apparatus comprising:
analog circuitry configured to communicate using analog signals;
digital circuitry; and
a clock circuit for providing a clock signal to the digital circuitry, wherein the frequency of the clock signal is varied in such a way that interference between the digital circuitry and the analog circuitry is reduced.
